(19) United States
(12) Patent Application Publication
(10) Pub. No.: US 2017/0344918 A1
(43) Pub. Date: Nov. 30, 2017

(54) FACILITATING AND REPORTING THE PROPER COMPLETION OF WORKFLOWS

(71) Applicant: HALLIBURTON ENERGY SERVICES, INC., Houston, TX (US)

(72) Inventors: Christopher Michael McMillon, Wylie, TX (US); Kenneth Lemoine Schwendemann, Flower Mound, TX (US)

(73) Assignee: HALLIBURTON ENERGY SERVICES, INC., Houston, TX (US)

(21) Appl. No.: 15/536,099

(22) PCT Filed: Feb. 26, 2015
(86) PCT No.: PCT/US2015/017801

§ 371 Date: Jun. 14, 2017

(51) Int. Cl. G06Q 10/06

(52) U.S. Cl. CPC G06Q 10/0633

(57) ABSTRACT

A method for facilitating the proper completion of a workflow in the oil and gas industry, in some embodiments, comprises obtaining a workflow comprising multiple workflow steps; displaying one or more of the workflow steps on a display; obtaining information pertaining to the displayed workflow steps, the information including at least one image and metadata associated with the at least one image; generating a report including the obtained information; and providing the report to a device via a network connection.

### BACKGROUND

Oil and gas personnel are routinely directed to complete tasks according to workflows specifically designed for those tasks. Such tasks vary widely in their natures and can include, for example, tasks for oil rig, drilling, logging and/or safety personnel. Properly completing these workflows is important, and the failure to do so can have significant safety, legal, financial and competitive implications.

Workflows, however, are often complex. They can be lengthy, detailed, technically challenging, and at times unclear. As a result, employees frequently take shortcuts and intentionally or unintentionally skip steps or perform steps inappropriately. They may also require assistance on certain steps that are difficult to perform alone. Methods and systems that facilitate the proper completion of workflows, therefore, are desirable.

### BRIEF DESCRIPTION OF THE DRAWINGS

Accordingly, there are disclosed in the drawings and in the following description methods and systems for facilitating the proper completion of workflows. In the drawings:

FIG. 1 is a block diagram of a system including multiple electronic devices used to facilitate the proper completion of workflows.

FIG. 2 is a series of illustrations depicting mobile device graphical user interfaces that may be used to facilitate proper workflow completion.

FIGS. 3A-3B are flow diagrams describing methods for performing the techniques described herein.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are techniques for using electronic devices to facilitate the proper completion of workflows. The techniques generally entail obtaining an electronic manual that describes how a particular workflow is to be performed and embedding within the manual instruction code that can be interpreted and processed by other electronic devices to create electronic tools. Such electronic devices include, for instance, smart phones that oil and gas personnel may carry and use in their work environments. Such an electronic device receives the electronic manual embedded with instruction code and generates an electronic tool based on the instruction code. The electronic device may use the electronic tool to interact with the user of the device, thereby facilitating proper completion of the workflow. The tool may, for instance, cause the user's electronic device to display workflow steps and receive input indicating completion of the steps (e.g., tactile affirmations, camera images pertaining to one or more workflow steps). The user electronic device then generates a report that is provided to the user for editing or is transmitted to a remote electronic device via a network for storage or review by another entity, such as the user's supervisor. The remainder of this disclosure assumes an illustrative scenario in which the user of the electronic device implementing the electronic tool is an employee and the user of the electronic device receiving workflow status reports is the employee's supervisor. The scope of this disclosure, however, is not limited to any aspect of this illustrative scenario and numerous other applications of the disclosed techniques are contemplated. For example, in some embodiments, numerous devices may be connected via the network 108, and these devices may communicate with one or more of the other devices in a manner described herein.

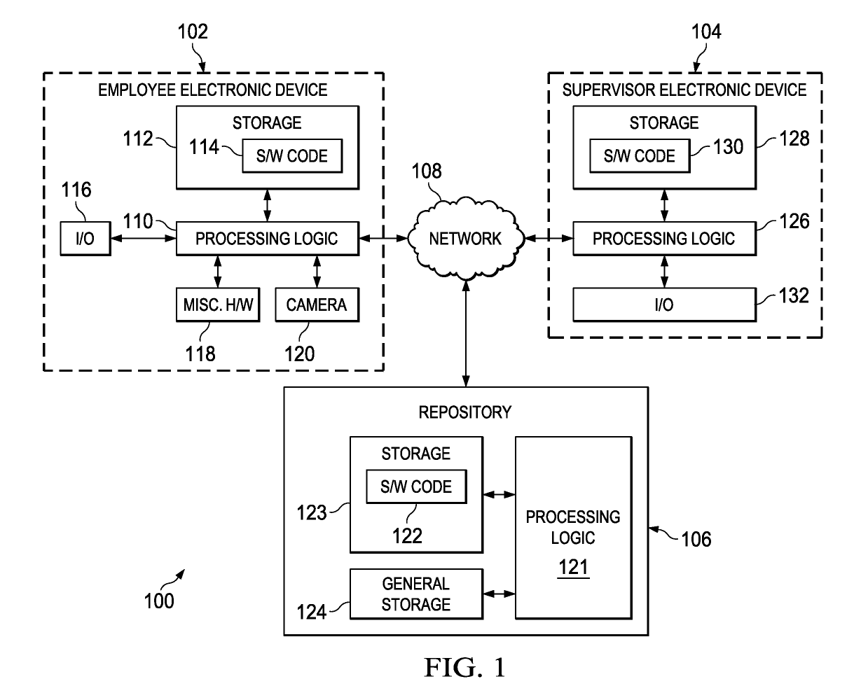

FIG. 1 is a block diagram of a system 100 including multiple electronic devices used to facilitate the proper completion of workflows. Specifically, the system 100 includes an employee electronic device 102, a supervisor electronic device 104, and a repository device 106, all of which communicate with each other via a network 108. The employee electronic device 102 is used by an employee of, e.g., an oil and gas firm, and the supervisor electronic device 104 is used by the employee's supervisor. As explained above, however, this illustrative scenario does not limit the scope of disclosure, which encompasses numerous alternative scenarios in which different entities use the electronic devices 102, 104. The repository device 106 serves as a centralized, network-based storage unit for storing reports and other data for later access and use. In some embodiments, the repository device 106 is a server, although it also may be a personal computer, some other type of workstation, a smart phone, or any other suitable type of electronic storage and communication device. Further, the repository device 106 may perform its operations automatically (e.g., by executing software code) or through a combination of software execution and human involvement. The network 108 may include the Internet, a virtual private network (VPN), an intranet, another suitable type of network, or some combination thereof. In some embodiments, the network 108 may include or be a direct connection between devices, such as a Bluetooth connection.

The employee electronic device 102 includes processing logic 110, storage 112 storing software code 114, input and/or output devices 116, miscellaneous hardware 118 and a camera 120. In some embodiments, the storage 112 is any suitable type of non-volatile memory. The software code 114, when executed, causes the processing logic 110 to perform some or all of the actions ascribed to the employee electronic device 102 herein. The software code 114 is not limited to a single software application and may include, for instance, an operating system, an application designed to facilitate interaction with the employee using the employee electronic device 102, and any other software that enables the processing logic 110 to perform the actions described herein. The input/output devices 116 vary and may include, for example and without limitation, a keyboard, a touchscreen, a stylus, a mouse, a touchpad, a microphone to receive audio input, a display, and any other suitable input/output device that facilitates communication between the employee electronic device 102 and the employee using the device 102. The miscellaneous hardware 118 includes other hardware that may enable the employee electronic device 102 to perform its duties, such as a global positioning service (GPS) unit. The camera 120 captures photos and/or video and provides it to the processing logic 110 for processing and subsequent storage or transmission. The camera 120 may be a built-in camera, such as a smart phone camera, or a detachable stand-alone camera, such as a universal serial bus (USB)-connected device.

As explained above, the repository device 106 serves as a network-based storage unit for the system 100. The repository device 106 includes processing logic 121 that couples to a preferably non-volatile storage 123 that stores software code 122. Software code 122, when executed, causes the processing logic 121 to perform the actions ascribed herein to the repository device 106, including, without limitation, responding to storage requests and access requests from other devices on the network 108. The processing logic 121 also couples to general storage 124. The general storage 124 is non-volatile storage and may take the form of or may include, e.g., a database. The general storage 124 may store, for instance, photos, video, reports, electronic manuals (whether modified with instruction code or not), and any other information that may be provided by or to devices on the network 108.

The supervisor electronic device 104 is any suitable electronic device capable of performing the actions ascribed to it. In some embodiments it takes the form of a personal computer or workstation, a smart phone, a tablet, or any other such computing device. The supervisor electronic device 104 includes processing logic 126, preferably non-volatile storage 128 storing software code 130, and input/output devices 132. The software code 130, when executed, causes the processing logic 126 to perform some or all of the actions herein attributed to the supervisor electronic device 104. In at least some embodiments, the input/output devices 132 are similar in type to the input/output devices 116.

The system 100 generally operates as follows. The repository device 106 has access to one or more electronic manuals, which are sets of instructions that describe how workflows are to be performed. The manuals may take the form of any readable document, such as an ADOBE ACROBAT® file, a MICROSOFT WORD® file, or a file having another proprietary format. The scope of disclosure is not necessarily limited to documents that resemble traditional instruction manuals. To the contrary, the term “electronic manual” is broad enough in scope to encompass any document or file that provides one or more instructions regarding the performance of a workflow. In some embodiments, an electronic manual is stored on the repository device 106, such as on general storage 124. In other embodiments, the electronic manual is accessible to the repository device 106 from another device via the network 108. Other storage scenarios for the electronic manuals are contemplated.

After obtaining access to an electronic manual, the repository device 106, which may also function as an administrator device, embeds code within the manual that enables another network-connected device (e.g., the employee electronic device 102) to use the electronic manual. Such embedded code is referred to herein as “instruction code,” and it takes the form of any type of software code or other text that the target device (e.g., the employee electronic device 102) is able to interpret. The instruction code may, for instance, enable the employee electronic device 102 to interpret the steps of the workflow described in the electronic manual and to create an electronic tool, described below, that assists the employee in proper completion of the workflow. In some embodiments, the repository device 106 is operated by a human administrator who programs the instruction code into the electronic manuals. In other embodiments, the software code 122 causes the processing logic 121 to recognize and interpret the content of each electronic manual (using appropriate text-recognition techniques and optionally by first converting the electronic manuals to other file formats as may be necessary) and to generate and embed the instruction code into the electronic manuals. The scope of disclosure is not limited to the embedding of instruction code solely by or through the repository device 106. Other devices on the network 108, whether illustrated or not illustrated in FIG. 1, may perform this function.

Once an electronic manual has been embedded with instruction code, the electronic manual is transmitted (e.g., via the network 108) to the employee electronic device 102. In some embodiments, the electronic manual is also transmitted to the supervisor electronic device 104 for storage or for future reference by the supervisor using the device 104. The employee electronic device 102 receives the electronic manual and the processing logic 110 locates and interprets the instruction code in the electronic manual. The processing logic 110 identifies the instruction code in any suitable manner. For example, in some embodiments the instruction code contains flags that signal the presence of instruction code to the processing logic 110. In other embodiments, the processing logic 110 may search the electronic manual for syntax that it may appropriately execute. Other such techniques are contemplated.

The software code 114 causes the processing logic 110 to use the instruction code to determine various aspects of the workflow associated with the electronic manual. The processing logic 110 uses that information about the workflow to generate an electronic tool. The electronic tool is software that the processing logic 110 may use to interact with the employee (e.g., using a smart phone “app” stored on storage 112). For example, when the employee determines that a particular task needs to be completed, he may access an interactive representation of the workflow (e.g., in a specialized app)—generated using the electronic tool corresponding to that workflow—on his device 102. The interactive representation of the workflow may display the workflow steps to the employee, enable the employee to affirm (e.g., by clicking or tapping a check box) that he has completed each step of the workflow, prompt the employee to provide photos, video or audio when appropriate, etc. In some embodiments, the processing logic 110 displays the workflow steps in modified form. For example, steps that are routinely performed by the employee may be truncated so that the workflow appears streamlined and uncluttered on the display. Conversely, new steps that the employee has not completed before may be emphasized in any suitable manner to bring such steps to the employee's attention, such as by using bold, underlined, italicized or highlighted text. The processing logic 110 receives the employee's input, including affirmations, image and/or video data, as well as any other suitable input such as text and audio, and generates a multimedia report using the input. In some embodiments, the report describes the steps of the workflow that were completed, the employee's input associated with one or more of the steps, as well as any other pertinent information that the employee electronic device 102 may have collected.

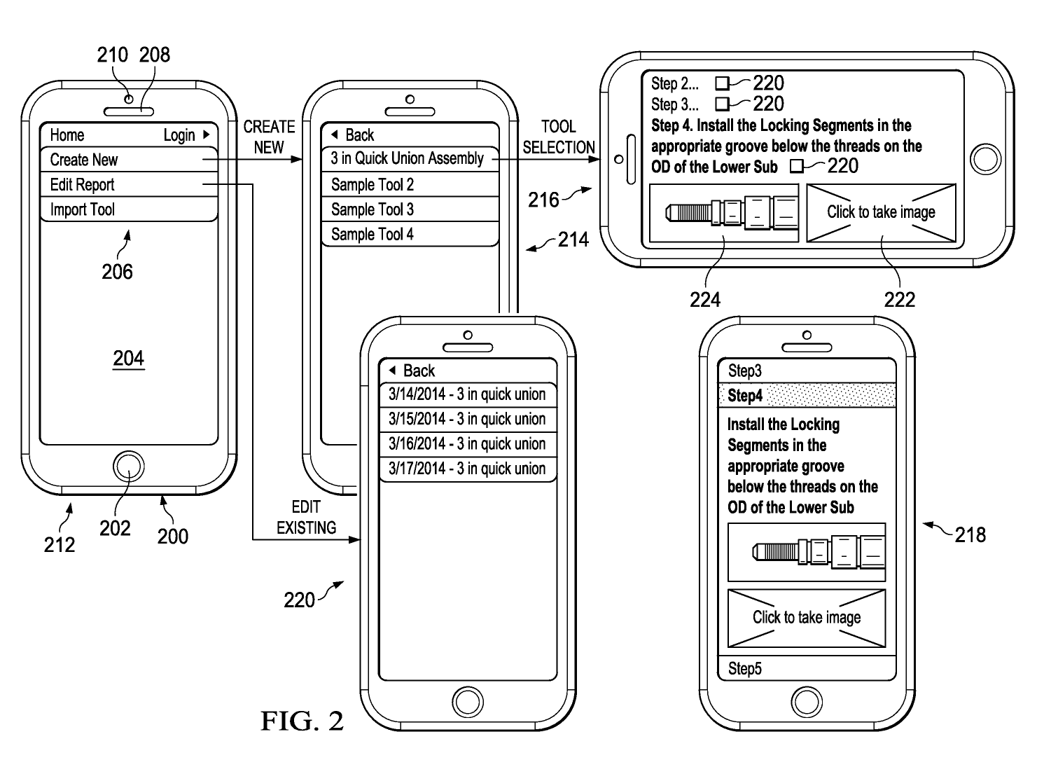

FIG. 2 is a series of illustrations 212, 214, 216, 218 and 220 depicting mobile device graphical user interfaces that may be used to facilitate proper workflow completion. Each of the illustrations shows a smart phone 200 (e.g., an IPHONE® device, an ANDROID® device) running an application that may be used to perform the techniques described herein. The smart phone 200 may include a button 202 usable to interact with the smart phone 200, a touch screen display 204, textual/graphical information 206 shown on the display 204, audio output 208, and a camera 210. In illustration 212, the display 204 shows a menu of the application that the employee uses to interact with one or more workflows. The menu shows miscellaneous options, such as a “home” option that links to a home screen and a “login” option that prompts the employee to enter secure credentials to allow access to secure electronic tools, secure records, and the like.

Logging in via the “login” option and selecting “import tool” causes the processing logic 110 to obtain a new electronic tool. In some embodiments, the processing logic 110 obtains the new electronic tool from another device coupled to the network 108, such as the repository device 106. In other embodiments, the processing logic 110 in response to the selection of “import tool” opens a browser through which the logic 110 navigates to a website dedicated to providing new electronic manuals to employee devices. The employee may select the appropriate electronic manual based on the task that he needs to complete, and that manual is downloaded and interpreted by the processing logic 110 to generate a new electronic tool. In yet other embodiments, the processing logic 110 in response to the selection of “import tool” automatically communicates with an external source to check for available electronic tools or manuals and enables the user to select one or more tools or manuals for download.

Still referring to illustration 212, selecting the “create new” feature causes the processing logic 110 to display a list of electronic tools to which the employee electronic device 102 has access. Included in this category are electronic tools that have already been imported to the device 102 using the “import tool” option. An illustrative electronic tool, called “3 in. Quick Union Assembly,” is shown in the illustration 214, as are illustrative sample tools 2-4. Each of these electronic tools has been obtained in the manner described above or in another suitable manner.

Selecting one of the electronic tools displayed as shown in illustration 214 causes the employee electronic device 102 to display a workflow corresponding to the selected electronic tool. Illustration 216 shows the workflow in a landscape view and illustration 218 shows the workflow in a portrait view. As shown in illustration 216, some of the steps of the workflow (here, steps 2 and 3) are truncated because the employee is familiar with those steps and truncating them provides a less cluttered appearance. (An employee's familiarity with a step of a workflow may be assessed, for example, by the number of times that the employee has historically affirmed completion of that particular step and comparing that number to a predetermined threshold.) Alongside each workflow step is a check box 220, which the employee may click (e.g., by touching the box if the device 102 is a touchscreen) to affirm completion of that step. Although not specifically shown, in some embodiments the display may include a “help” icon next to each step that the employee may select to obtain help with a particular step of a workflow. The device 102 may, for example, display a portion of a corresponding manual or connect the employee with a supervisor for a phone call or video conference to discuss the problem. The scope of disclosure is not limited to these examples of affirmation and seeking help, and other variations on these examples are contemplated. In some embodiments, clicking on the check box 220 or otherwise affirming completion of a step may cause the device 102 to immediately capture and store the GPS coordinates of the device 102 and a time stamp.

In contrast to the truncated steps 2 and 3, step 4 is not truncated and is instead displayed in bold to draw the employee's attention, since step 4 is a step with which the employee is unfamiliar. The employee also may upload images by clicking on icons such as icon 222. Numeral 224 displays such an image taken by the employee and uploaded to the application. In some embodiments, clicking on such an icon prompts the employee to provide audio input, video input or some other type of input. Illustration 218 is similar to illustration 216 and, therefore, its particulars are not described.

When the workflow screen is closed, the device 102 generates a report describing the workflow. Information included in the report varies in scope and may include, without limitation, data about the workflow steps; information about whether the steps were completed; multimedia data input provided by the employee; and any other input (e.g., notes or other annotations) provided by the employee. The report may include other information as well. For example, the device 102 may extract metadata from captured images (e.g., a date on which an image was captured by a camera; a time at which the image was captured by the camera; global positioning system (GPS) coordinates of the camera at that date and time; an identification of a user of the camera at that date and time) and include the metadata as part of the information in the report. The report also may include any other GPS coordinates and time stamps that were captured with the completion of each step in the workflow.

Referring again to illustration 212, selecting the “edit report” option causes the employee electronic device 102 to display a list of editable reports that have been created to date. Illustration 220 shows an illustrative report list. Each of the four illustrative reports in the list has been created using the “3 in. Quick Union Assembly” electronic tool, with the first report created on Mar. 14, 2014 and the latest report created on Mar. 17, 2014. Each of the reports describes the completion of a different instance of the same or similar task—that is, each of these four tasks entailed use of the 3 in. Quick Union Assembly tool and workflow. Selecting any of the editable reports enables the employee to edit the report. In some embodiments, at least some aspects of the report are not editable, as in the case where the employee may be incentivized to falsify those aspects of the report.

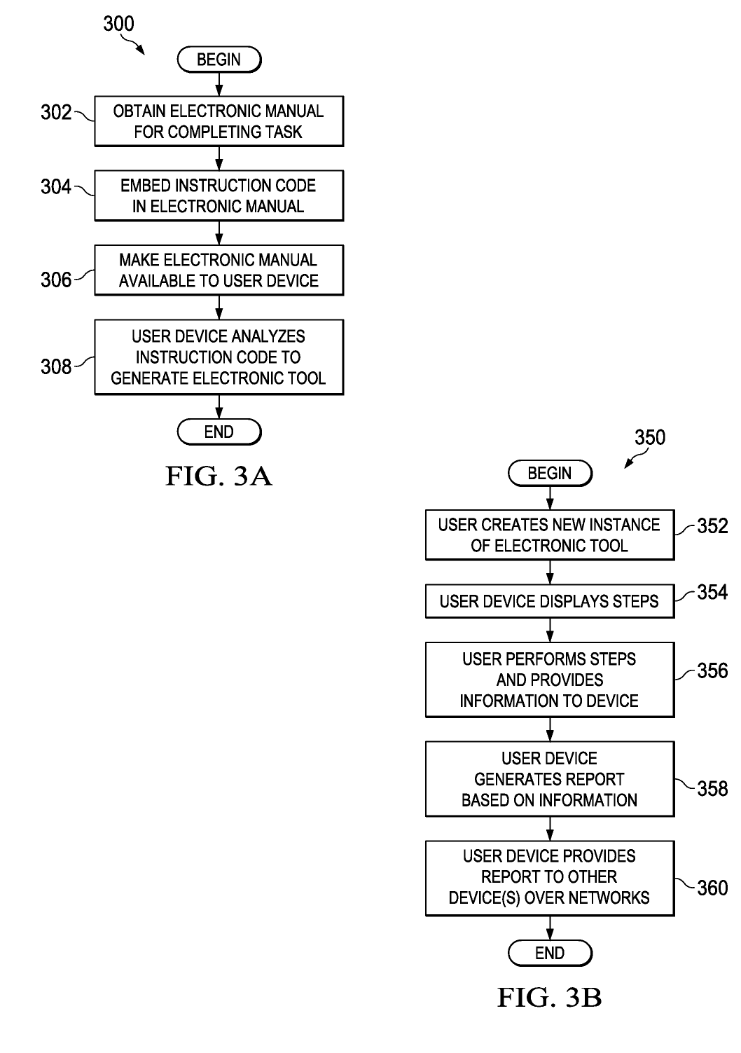

FIGS. 3A-3B are flow diagrams describing methods usable to perform the techniques described herein. In particular, FIG. 3A shows a method 300 that may be used to generate electronic tools, and FIG. 3B shows a method 350 that may be used to employ an electronic tool to perform a task and generate a report. Method 300 begins by obtaining an electronic manual for completing the task in question (step 302). The method 300 then includes embedding instruction code in the electronic manual (step 304). The electronic manual is made available to the employee device (step 306), and the employee device analyzes the instruction code embedded in the electronic manual to generate an electronic tool (step 308). Each of these steps 302, 304, 306 and 308 is described in detail above.

The method 350 may be used after a suitable electronic tool has been obtained. The method 350 includes creating a new instance of the electronic tool (step 352). Referring briefly to FIG. 2, a new instance of the tool may be created, for example, by selecting that tool in the list shown in illustration 214. Referring again to FIG. 3B, the method 350 next includes the employee device displaying the steps of the workflow (step 354; as shown, for instance, in illustrations 216 and 218 in FIG. 2). The method 350 includes the employee performing the steps and providing information to the device accordingly (step 356). As explained in detail above, such information can include, without limitation, affirmations of step completion; text input; audio input; video input; image input; and any other suitable type of input in response to each of the steps. The method 350 further includes generating a report based on the workflow and the information received (step 358). Finally, the method 350 includes the employee device providing the report to other device(s) over a network (step 360). Such other devices may include, for example, the repository device 106 (or some other suitable storage repository), the supervisor electronic device 104, and/or any other suitable device. In some embodiments, the report may be stored on local storage for the device 102 in lieu of or in addition to transmission over a network. In some embodiments, the report may be stored for future reference after a user of the supervisor device 104 reviews and approves the report, including any or all of the various types of information described above.

The present disclosure encompasses numerous embodiments. At least some of these embodiments are directed to a method for facilitating the proper completion of a workflow in the oil and gas industry, comprising: obtaining a workflow comprising multiple workflow steps; displaying one or more of the workflow steps on a display; obtaining information pertaining to the displayed workflow steps, the information including at least one image and metadata associated with the at least one image; generating a report including the obtained information; and providing the report to a device via a network connection. Such embodiments may be supplemented in a variety of ways, including by adding any of the following concepts in any sequence and in any combination: obtaining an electronic manual describing the workflow; embedding instruction code in the electronic manual; and a processor automatically interpreting the instruction code and using the instruction code to generate an electronic tool, said electronic tool comprising the workflow; generating an instance of the electronic tool as a result of a user command, said instance comprising the workflow; wherein said information includes affirmations that said displayed workflow steps have been completed; wherein said at least one image pertains to one or more of the displayed workflow steps; wherein said metadata includes data selected from the group consisting of: a date on which said at least one image was captured by a camera; a time at which said at least one image was captured by the camera; global positioning system (GPS) coordinates of said camera at said date and time; and an identification of a user of the camera at said date and time; further comprising receiving the report and analyzing the report to evaluate completion of the workflow steps; wherein the at least one image is captured using a smart phone or a personal computer; further comprising emphasizing at least one of the displayed workflow steps to signify a new procedure; further comprising truncating one or more of the displayed workflow steps; and further comprising displaying a list of generated reports and enabling a user to edit one or more of the generated reports.

At least some embodiments are directed to a device to evaluate workflow completion, comprising: processing logic; a display coupled to the processing logic; an input device coupled to the processing logic; a camera coupled to the processing logic; and storage coupled to the processing logic and comprising software code, which, when executed, causes the processing logic to display a multi-step workflow on the display, obtain information pertaining to performance of each of the workflow steps via the input device, and generate a report including said information, wherein the information includes an image captured by the camera and pertaining to the workflow and further includes metadata associated with the image. Such embodiments may be supplemented in a variety of ways, including by adding any of the following concepts in any sequence and in any combination: wherein the processing logic interprets instruction code embedded in an electronic manual to generate an electronic tool comprising the workflow; wherein the processing logic generates an instance of the electronic tool, said instance comprising the workflow; wherein the processing logic enables a user to edit a report corresponding to said instance; and wherein the processing logic accesses the electronic manual from a network using an internet browser as a result of a user command.

At least some embodiments are directed to a system for assessing workflow performance, comprising: storage coupled to a network and comprising an electronic manual containing instruction code; a first electronic device, coupled to the network, to access the electronic manual, generate an electronic tool based on said instruction code in the electronic manual, display a multi-step workflow based on the electronic tool, obtain information pertaining to the performance of each of the workflow steps, and generate a report based on said information; and a second electronic device, coupled to the network, to receive the report from the first electronic device and to display the report, wherein said information includes one or more images pertaining to the performance of at least one of the workflow steps. Such embodiments may be supplemented in a variety of ways, including by adding any of the following concepts in any sequence and in any combination: wherein the first electronic device accesses the electronic manual from the storage using a web browser; wherein the information further comprises metadata pertaining to the one or more images; and wherein said information includes affirmations that said workflow steps were completed and further includes global positioning system (GPS) coordinates and time stamps associated with said affirmations.

What is claimed is:

1. A method for facilitating the proper completion of a workflow in the oil and gas industry, comprising:
obtaining a workflow comprising multiple workflow steps;
displaying one or more of said workflow steps on a display;
obtaining information pertaining to said displayed workflow steps, said information including at least one image and metadata associated with said at least one image;
generating a report including the obtained information; and
providing said report to a device via a network connection.

2. The method of claim 1, further comprising:
obtaining an electronic manual describing the workflow;
embedding instruction code in the electronic manual; and
a processor automatically interpreting the instruction code and using the instruction code to generate an electronic tool, said electronic tool comprising the workflow.

3. The method of claim 2, further comprising generating an instance of the electronic tool as a result of a user command, said instance comprising the workflow.

4. The method of claim 1, wherein said information includes affirmations that said displayed workflow steps have been completed.

5. The method of claim 1, wherein said at least one image pertains to one or more of the displayed workflow steps.

6. The method of claim 1, wherein said metadata includes data selected from the group consisting of: a date on which said at least one image was captured by a camera; a time at which said at least one image was captured by the camera; global positioning system (GPS) coordinates of said camera at said date and time; and an identification of a user of the camera at said date and time.

7. The method of claim 1, further comprising receiving the report and analyzing the report to evaluate completion of the workflow steps.

8. The method of claim 1, wherein the at least one image is captured using a smart phone or a personal computer.

9. The method of claim 1, further comprising emphasizing at least one of the displayed workflow steps to signify a new procedure.

10. The method of claim 1, further comprising truncating one or more of the displayed workflow steps.

11. The method of claim 1, further comprising displaying a list of generated reports and enabling a user to edit one or more of the generated reports.

12. A device to evaluate workflow completion, comprising:
processing logic;
a display coupled to the processing logic;
an input device coupled to the processing logic;
a camera coupled to the processing logic; and
storage coupled to the processing logic and comprising software code, which, when executed, causes the processing logic to display a multi-step workflow on the display, obtain information pertaining to performance of each of the workflow steps via the input device, and generate a report including said information,
wherein the information includes an image captured by the camera and pertaining to the workflow and further includes metadata associated with the image.

13. The device of claim 12, wherein the processing logic interprets instruction code embedded in an electronic manual to generate an electronic tool comprising the workflow.

14. The device of claim 13, wherein the processing logic generates an instance of the electronic tool, said instance comprising the workflow.

15. The device of claim 14, wherein the processing logic enables a user to edit a report corresponding to said instance.

16. The device of claim 13, wherein the processing logic accesses the electronic manual from a network using an internet browser as a result of a user command.

17. A system for assessing workflow performance, comprising:
storage coupled to a network and comprising an electronic manual containing instruction code;
a first electronic device, coupled to the network, to access the electronic manual, generate an electronic tool based on said instruction code in the electronic manual, display a multi-step workflow based on the electronic tool, obtain information pertaining to the performance of each of the workflow steps, and generate a report based on said information; and
a second electronic device, coupled to the network, to receive the report from the first electronic device and to display the report,
wherein said information includes one or more images pertaining to the performance of at least one of the workflow steps.

18. The system of claim 17, wherein the first electronic device accesses the electronic manual from the storage using a web browser.

19. The system of claim 17, wherein the information further comprises metadata pertaining to the one or more images.

20. The system of claim 17, wherein said information includes affirmations that said workflow steps were completed and further includes global positioning system (GPS) coordinates and time stamps associated with said affirmations.
